(19) United States
(12) Patent Application Publication
(10) Pub. No.: US 2014/0002643 A1
(43) Pub. Date: Jan. 2, 2014

(54) PRESENTATION OF AUGMENTED REALITY IMAGES ON MOBILE COMPUTING DEVICES

(71) Applicants: Bilal Aziz, Durham, NC (US); Phuc K. Do, Morrisville, NC (US); Justin M. Pierce, Cary, NC (US); Andrew D. Vodopia, Durham, NC (US)

(72) Inventors: Bilal Aziz, Durham, NC (US); Phuc K. Do, Morrisville, NC (US); Justin M. Pierce, Cary, NC (US); Andrew D. Vodopia, Durham, NC (US)

(73) Assignee: INTERNATIONAL BUSINESS MACHINES CORPORATION, Armonk, NY (US)

(21) Appl. No.: 13/534,518

(22) Filed: Jun. 27, 2012

(51) Int. Cl. H04N 7/18; G06Q 30/08; G06Q 30/00; G09G 5/00

(52) U.S. Cl. 348/143; 345/633; 705/26.3; 705/26.1; 348/E07.085

(57) ABSTRACT

In accordance with one or more embodiments of the present invention, methods and systems disclosed herein provide for presentation of augmented reality images on mobile computing devices. An example method includes determining a measure of user interaction with a mobile computing device. The method may also include determining whether a user attention criterion is met based on the measure. Further, the method may include presenting an augmented reality image on a display in response to determining that the user attention criterion is met.

### BACKGROUND

1. Field of the Invention

The present invention relates to augmented reality systems, and more specifically, to presenting augmented reality images on mobile computing devices.

2. Description of Related Art

In retail environments, such as grocery stores and other “brick and mortar” stores, many products are available for sale to consumers at various prices. Often, shoppers will carry their mobile computing devices, such as smart phones and tablet computers, into stores. Such devices may be used to compare prices for products available in the store with prices for the same or comparable products available for sale via the Internet. In other instances, shoppers may capture images or video of products or the retail environment for sharing the images or video over the Internet. Thus, the use of mobile computing devices by shoppers in retail environments has become common. Accordingly, it is desired to provide mobile computing devices and other computing devices with capabilities for improving the shopping experiences of shoppers within retail environments.

### BRIEF SUMMARY

In accordance with one or more embodiments of the present invention, methods and systems disclosed herein provide for presenting an augmented reality image. An example method includes determining a measure of user interaction with a mobile computing device. The method may also include determining whether a user attention criterion is met based on the measure. Further, the method may include presenting an augmented reality image on a display in response to determining that the user attention criterion is met.

In accordance with one or more embodiments of the present invention, methods and systems disclosed herein provide for providing product image capture time and statistical data to a serving computing device within a retail environment. An example method includes determining an amount of time spent capturing an image of an object within a retail environment. The method may also include generating statistical data associated with the object. Further, the method may include communicating the amount of time spent and the statistical data to a serving computing device within the retail environment.

In accordance with one or more embodiments of the present invention, methods and systems disclosed herein provide for presenting an augmented reality image associated with a selected bid. An example method includes receiving a plurality of bids from a plurality of entities associated with the objects. The method may also include selecting one of the bids. Further, the method may include presenting, on a display, an augmented reality image associated with the selected bid.

In accordance with one or more embodiments of the present invention, methods and systems disclosed herein provide for implementing an action at a serving computing device. An example method includes applying a criterion to each of a plurality of objects within one or more images captured by a mobile computing device within a retail environment. Further, the method may include determining whether one of the objects meets the criterion. The method may also include implementing a predetermined action at a serving computing device in response to determining that one of the objects meets the criterion.

### BRIEF DESCRIPTION OF THE SEVERAL VIEWS OF THE DRAWINGS

FIG. 1 is a block diagram of a system according to embodiments of the present invention;

FIG. 2 is a flowchart of an example method for presenting an augmented reality image in accordance with embodiments of the present invention;

FIG. 3 depicts a display screen showing example images in accordance with embodiments of the present invention;

FIG. 4 is a flowchart of an example method for providing product image capture time and statistical data to a serving computing device within a retail environment in accordance with embodiments of the present invention;

FIG. 5 is a flowchart of an example method for presenting an augmented reality image associated with a selected bid in accordance with embodiments of the present invention;

FIG. 6 depicts a display screen showing an image including multiple products and augmented reality images in accordance with embodiments of the present invention; and

FIG. 7 is a flowchart of an example method for implementing an action at a serving computing device in accordance with embodiments of the present invention.

### DETAILED DESCRIPTION

Exemplary systems and methods for presenting an augmented reality image on a display in accordance with embodiments of the present invention are disclosed herein. Particularly, methods in accordance with embodiments of the present invention may be implemented by one or both of a mobile computing device and a serving computing device located within a retail environment or a “brick and mortar” store having a products for browse and purchase by a customer. In an example, a customer browsing products within a retail environment may activate or turn on an image capture device of his or her mobile computing device. The mobile computing device may be, for example, but not limited to, a smart phone or a tablet computer. The image capture device may be any suitable camera configured for capturing one or more images or video. The user of the mobile computing device may move within the retail environment while using the image capture device to capture images of products or other objects. The mobile computing device may determine an amount of time spent capturing an image of an object and determine whether the amount of time exceeds a predetermined threshold. In response to determining that the threshold is met, an augmented reality image may be presented on a display of the mobile computing device. For example, an advertisement image, text, discount information, product nutrition information, and/or the like may be presented on the display.

As referred to herein, the term “computing device” should be broadly construed. For example, the computing device may be a mobile computing device, such as a smart phone, including a camera configured to capture one or more images of a product. A computing device may be a mobile electronic device such as, for example, but not limited to, a smart phone, a cell phone, a pager, a personal digital assistant (PDA, e.g., with GPRS NIC), a mobile computer with a smart phone client, or the like. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile computing device is a cellular telephone or smart phone that operates over GPRS (General Packet Radio Services), which is a data technology for GSM networks. In addition to a conventional voice communication, a given mobile computing device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, and the like. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

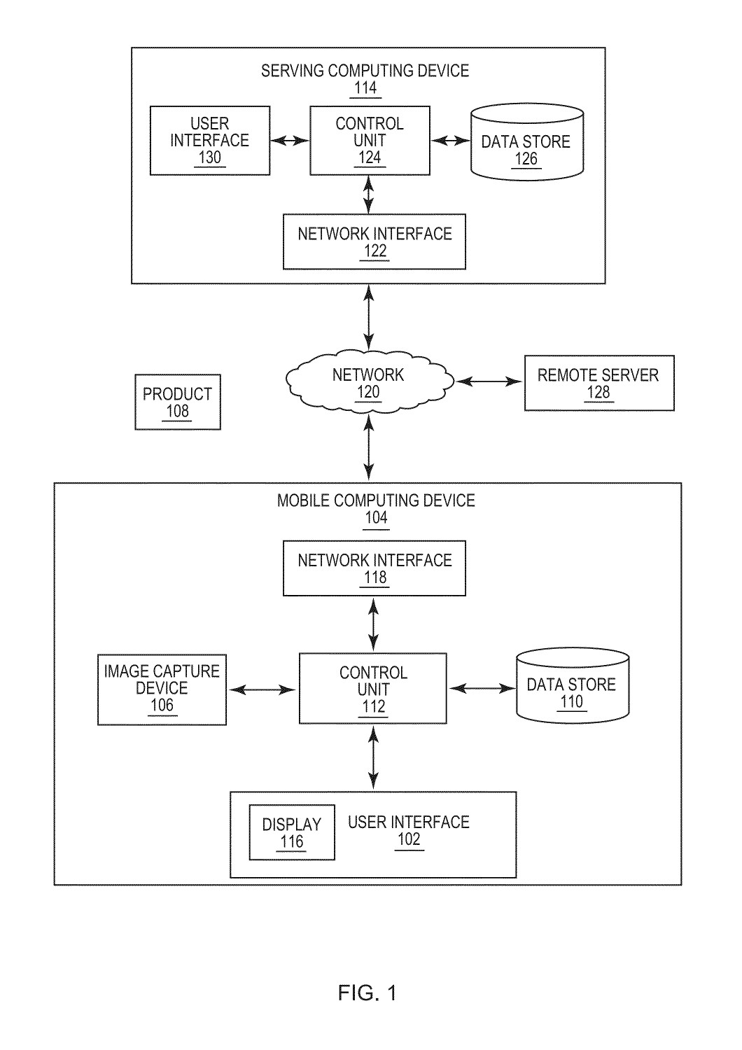

The presently disclosed invention is now described in more detail. For example, FIG. 1 illustrates a block diagram of a system 100 according to embodiments of the present invention. The system 100 may be implemented in whole or in part in any suitable retail environment. For example, the system 100 may be implemented in a retail store having a variety of products positioned throughout the store for browse and purchase by customers. Customers may collect one or more of the products for purchase and proceed to a point of sale (POS) terminal to conduct a suitable purchase transaction for purchase of the products. While moving through the retail environment, the user may interact with a user interface 102 of his or her mobile computing device 104 to control an image capture device 106 to capture one or more images or video within the retail environment. The captured images or video may include one or more products and/or scenery within the retail environment. For example, captured video may include an image of a product 108.

Captured images or video may be stored in a data store 110 residing on the mobile computing device 104. As an alternative, the images or video may be directly captured and presented to the user in real time on a display 116. The data store 110 may be any suitable memory configured to store image or video data, computer readable program code, and other data. A control unit 112 of the mobile computing device 104 may analyze the image or video data to determine an amount of time spent capturing the image or video of the product 108. The amount of time may be a measure of user attention given to the product 108. More generally, the amount of time may be a measure of user interaction with the mobile computing device 104. This measure may be further analyzed by the mobile computing device 104 or a serving computing device 114 for determining whether to present an augmented reality image on the display 116 of the mobile computing device 104.

As referred to herein, the term “augmented reality image” is generally a displayed image of an environment whose elements are augmented. For example, one or more images captured by a computing device may be augmented to include advertisement information, text, discount information, product nutrition information, and the like. Further, an augmented reality image may displayed in real time. For example, as an image or video is being captured, the corresponding augmented reality image may be simultaneously displayed. In another example, as an image of a product is being captured by a mobile computing device, the image of the product may be displayed along with an augmented reality image in accordance with embodiments of the present invention.

According to embodiments of the present invention, a user of the mobile computing device 104 may use an application (often referred to as an “app”) residing on the computing device 104 to interact with the computing device 104 for implementing the functions according to embodiments of the present invention. The application may reside on the computing device 104 and may be part of the control unit 112. The user may, for example, input commands into the user interface 102 for controlling the image capture device 106 to acquire images or video of products and scenery within a retail environment. The user may also, for example, position the computing device 104 relative to the product 108, other items, or scenery such that the image capture device 106 can acquire images or video of such objects or scenery. The application may have been downloaded from a web server and installed on the computing device 104 in any suitable manner. The application may be downloaded to another machine and then transferred to the computing device. In an example, the application can enable the computing device 104 with one or more of the features according to embodiments of the present invention.

In accordance with embodiments of the present invention, the control unit 112 may analyze captured images and/or video to recognize one or more objects within the images and/or video. For example, a user may position the mobile computing device 104 relative to the product 108 such that a camera of the mobile computing device 104 can capture an image of a portion or all of the product 108. The captured image may include, for example, a label identifying the product and/or features of the product, such as a shape and/or color, that can be analyzed to identify the product. In response to capture of the image, the control unit 112 may control the display 116 to display the image of the object. Further, the control unit 112 may control the display 112 to display an augmented reality image along with the object image in accordance with the present invention.

The mobile computing device 104 may suitably communicate with the serving computing device 114 to exchange data, such as images and videos captured by the mobile computing device 104 and other information in accordance with embodiments of the present invention. Communication between the mobile computing device 104 and the serving computing device 114 may be implemented via any suitable technique and any suitable communications network. For example, the mobile computing device 104 and the serving computing device 114 may interface with one another to communicate or share data over a suitable communications network, such as, but not limited to, the Internet, a local area network (LAN), or a wireless network, such as a cellular network. As an example, the mobile computing device 104 and the serving computing device 114 may communicate with one another via a WI-FI® connection or via a web-based application.

The control unit 112 may be implemented by hardware, software, firmware, of combinations thereof. For example, software residing on the data store 110 may include instructions implemented by a processor for carrying out functions of the control unit 112 disclosed herein.

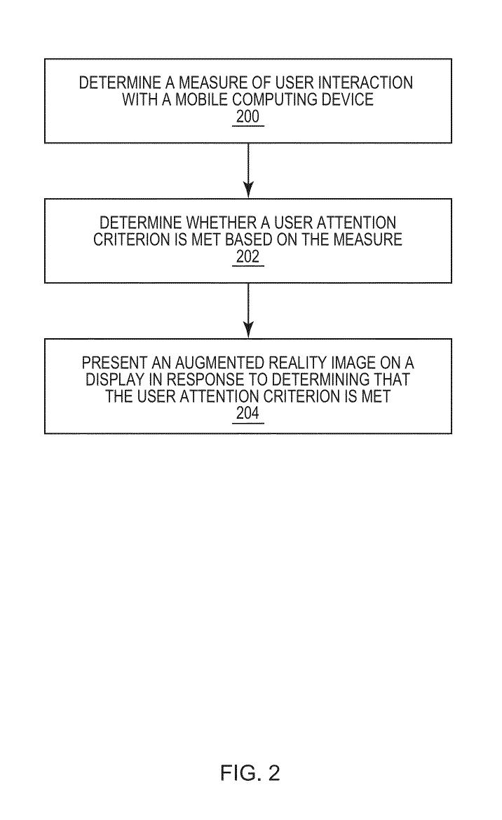

FIG. 2 illustrates a flowchart of an example method for presenting an augmented reality image in accordance with embodiments of the present invention. The method of FIG. 2 is described as being implemented by the mobile computing device 104 shown in FIG. 1, although the method may be implemented by any suitable computing device or in combination with another computing device, such as the serving computing device 114. The method may be implemented by hardware, software, and/or firmware of the mobile computing device 104 and/or another computing device.

Referring to FIG. 2, the method includes determining 200 a measure of user interaction with a mobile computing device. For example, a user of the mobile computing device 104 may interact with and position the device 104 for capturing a video of the product 108. The image capture device 106 can capture the video of the product 108. The video may be stored within the data store 110. Capture of an image or video of the product can be used for measuring user interaction with the mobile computing device. For example, a time of the video capture or other characteristics of the user's control of the video capture can be used for measuring the user interaction with the mobile computing device.

The method of FIG. 2 includes determining 202 whether a user attention criterion is met based on the measure. Continuing the aforementioned example of the captured video of the product 108, the control unit 112 may determine whether the user attention criterion is met based on the amount of time spent capturing video of the product 108. For example, the control unit 112 may determine whether the amount of time spent capturing the video exceeds a predetermined threshold (e.g., 5 seconds).

The method of FIG. 2 includes presenting 204 an augmented reality image on a display in response to determining that the user attention criterion is met. Continuing the aforementioned example, the control unit 112 may send a communication to the serving computing device 114 to indicate that the threshold was met for the product 108 in response to determining that the amount of time spent capturing video of the product 108 exceeds the threshold. The communication may include an image of the product 108 or other identification of the product 108. Further, control unit 112 may control a network interface 118 to send the communication to the serving computing device 114 via a network 120. The network 120 may be any suitable network such as, but not limited to, a WI-FI® network or other wireless network. Subsequently, a network interface 122 of the serving computing device 114 may receive the communication from the network 120. In response to receipt of the communication, a control unit 124 of the device 114 may identify the product 108 based on the communication and use the identification to perform a lookup in a data store 126 for an augmented reality image associated with the product 108 in accordance with embodiments of the present invention. Subsequently, the control unit 124 may control the network interface 112 to send the augmented reality image to the device 104 via the network 120. The control unit 112 may subsequently control the display 116 to present the augmented reality image together with the captured video of the product 108. As an example, the augmented reality image may include one or more of an advertisement image, text, discount information, product nutrition information, and the like.

In accordance with embodiments of the present invention, entities, such as companies, may pay for placing their content within an augmented reality image. For example, a company may pay for advertisement placement or other content placement within an augmented reality image displayed on a mobile computing device as described herein. In another example, a company may only need to pay if a user's behavior or purchases are affected by an advertisement. As an example, if a condiment manufacturer bids for advertisement to be displayed, they may only pay if a user subsequently looks at the product or purchases the product.

In accordance with embodiments of the present invention, multiple companies may place bids to present their content within an augmented reality image displayed on a mobile computing device. Representatives of the companies may each operate a computing device to access the serving computing device 114, a server 128 remote from the retail environment, or another suitable computing device. The companies may each be registered with a service that accepts bids for placement of content within augmented reality images presented on mobile computing devices.

In an example bidding process, a company may provide the remote server 128 with one or more bids and content. Other companies may similarly communicate to the remote server 128 bids and content to be displayed if a corresponding bid wins. The remote server 128 or the serving computing device 114 may select one or more of the bids. For example, a bid may be selected if it is the highest among other competing bids. The content may also be associated with user interaction measures as described herein. In response to determining that user attention criterion is met, the serving computing device 114 may provide content corresponding with the winning bid to the mobile computing device 104 for presentation with an augmented reality image in accordance with embodiments of the present invention.

Subsequent to presenting content corresponding to a bid within an augmented reality image, a payment transaction with a company or other entity may be conducted. For example, a suitable banking transaction may be implemented such that payment is provided by the company to an owner of the retail environment. Payment may be made in response to the augmented reality image being displayed.

In accordance with embodiments of the present invention, a retail environment owner may provide to other companies information about its customers. Such information may have been collected from customers, for example, during a customer loyalty registration process and/or while customers are shopping within the retail environment. For example, various retailers have customer loyalty programs to incentivize customers to provide their demographic data and the like. In another example, a retailer may collect information from a customer through the customer's mobile computing device. For example, the mobile computing device 104 may communicate to the serving computing device 114 information such as, but not limited to, user shopping cart content, user shopping history, number of products of a particular type in a shopping cart, and the like. In an example, the image capture device 106 may capture images or video of the customer placing products in his or her cart, products that the customer is browsing, and the like. Such images may be analyzed to identify products, shopping experience data, and the like. This information can be communicated by the serving computing device 114 to the remote server 128 for further analysis and distribution to computing devices of various companies. Based on this information, representatives of the companies may determine bids for placing augmented reality images on mobile computing devices with a retail environment of the retailer.

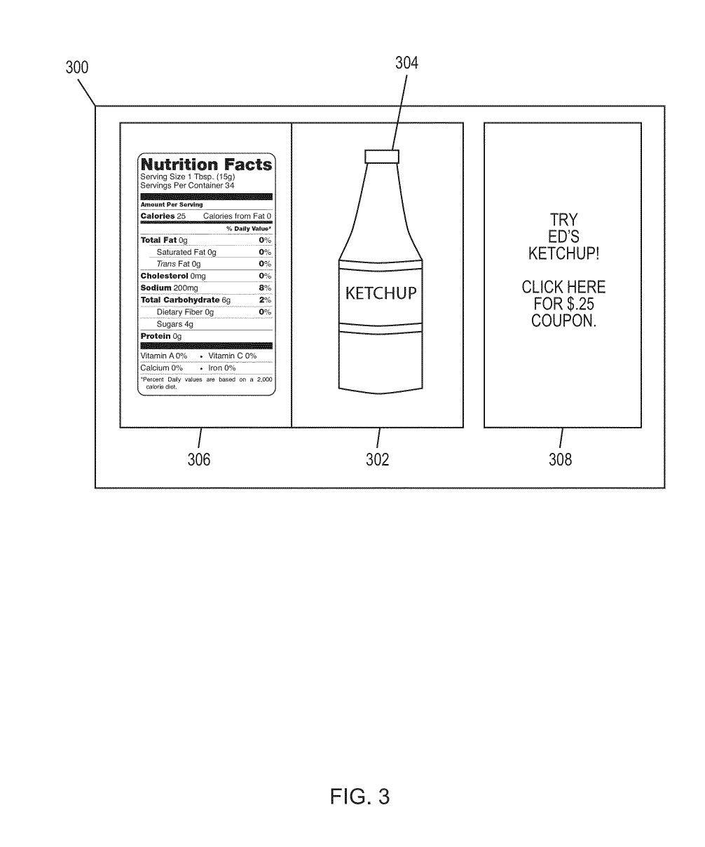

FIG. 3 illustrates a display screen 300 showing example images in accordance with embodiments of the present invention. In this example, the display screen may be integrated with any suitable computing device, such as the mobile computing device 104 shown in FIG. 1. The display screen may be a part of the display 116. Referring to FIG. 3, the display screen 300 may display a window 302 including one or more images or video captured by an image capture device of a mobile computing device. For example, the window 302 may include real-time video of a product 304. The product 304 may be in view of the image capture device 106 while the shopper is browsing the product 304 and one or more other products within the retail environment. The product 304 may be deemed to be a recipient of user attention since video of the product 304 has been captured. As described herein, the more time spent capturing video of the product 304, the higher the measure of user attention associated with the product 304.

In accordance with embodiments of the present invention, the mobile computing device 104 and/or serving computing device 114 may recognize or identify the product 304. The control unit 112 may analyze an image or video containing the product 304 to identify the product 304. Further, the computing device 104 and/or serving computing device 114 may store information and/or images associated with the product 304 or other products. In response to identifying the product 304, the information and/or images associated with the product 304 may be displayed within a window 306, which is an augmented reality image. Further, the control unit 112 may control the display 116 to display a window 308 containing an advertisement. The advertisement may be an augmented reality image corresponding to a company that won a bid to present the image in accordance with embodiments of the present invention.

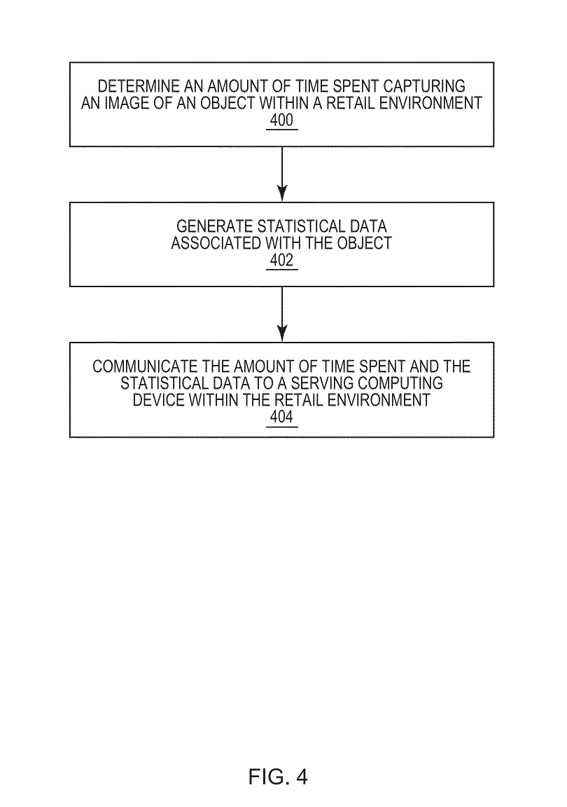

FIG. 4 illustrates a flowchart of an example method for providing product image capture time and statistical data to a serving computing device within a retail environment in accordance with embodiments of the present invention. The method of FIG. 4 is described as being implemented by the mobile computing device 104 shown in FIG. 1, although the method may be implemented by any suitable computing device or in combination with another computing device, such as the serving computing device 114. The method may be implemented by hardware, software, and/or firmware of the mobile computing device 104 and/or another computing device.

Referring to FIG. 4, the method includes determining 400 an amount of time spent capturing an image of an object within a retail environment. For example, the control unit 112 may control the image capture device 106 to capture one or more images or video of a product, such as the product 304 shown in FIG. 3. The control unit 112 may utilize suitable image recognition techniques to identify the object within the captured image(s) or video. Further, the control unit 112 may determine the amount of time spent capturing the image(s) or video of the identified object using any suitable technique. The determined time amount may be stored in the data store 110.

In an example of identifying an object, the object may be identified based on whether the object is picked up by a user and/or the object is placed away. For example, the control unit 112 may analyze one or more images or video of the product 304 to determine whether the product 304 is being picked up by a user or being placed away by the user. The control unit 112 may, for example, apply suitable recognition techniques for determining whether the user is removing the product from a shelf or placing the product on a shelf. As a result of recognizing such actions, the control unit 112 may determine that user attention is being provided to the product. Recognizing such actions may be representative of a measure of user interaction or user attention given to the product in accordance with embodiments of the present invention.

In another example of identifying an object, an object may be identified based on how long the object is in frame of a video being captured. The object may move within the frame based on user positioning of a device; however, the object may be tracked to determine how long it is within frame. The determined time may be used to identify the object.

In another example of identifying an object, the object may be identified based on whether the object is analyzed for nutritional information. For example, the control unit 112 may analyze one or more images or video of the product 304 to determine whether the product 304 is being analyzed for nutritional information. The control unit 112 may, for example, apply suitable recognition techniques for determining whether the product is being held by a user and the nutritional information is in view. It may be inferred that the nutritional information is being analyzed by a shopper if the nutritional information is in view for greater than a predetermined time period. Recognizing such an action may be representative of a measure of user interaction or user attention given to the product in accordance with embodiments of the present invention.

The method of FIG. 4 includes generating 402 statistical data associated with the object. For example, the mobile computing device 104 may determine an amount of time spent capturing one or more images or video of a product. Such time may be tracked for statistical data such as, but not limited to, products that are picked up, products that are put back, items that are analyzed for nutritional information, items that are shared via a social network, and/or the like. The control unit 112 may coordinate the collection of the statistical data using components of the mobile computing device 104. The statistical data may be stored in the data store 110.

The method of FIG. 4 includes communicating 404 the amount of time spent and the statistical data to a serving computing device within the retail environment. For example, the control unit 112 of the mobile computing device 104 may control the network interface 118 to communicate some or all of the statistical data to the serving computing device 114. The serving computing device 114 may further analyze the statistical data to generate other statistical data. A retailer may interact with a user interface 130 to view the statistical data for assessing, for example, product placement and the like. Subsequently, the serving computing device 114 may communicate some or all of the statistical data to other computing devices accessible by an entity, such as a manufacturer, for assessing advertising and the like.

In an example scenario, a shopper or user may enter a retail environment carrying the mobile computing device 104. Upon entering the retail environment, the shopper may invoke an application residing on the device 104 that automatically logged into the serving computing device 114. As the shopper browses products within the aisles of the retail environment, statistical data may be generated and combined with statistical data generated by the mobile computing devices of other shoppers. The statistical data may be communicated by each of the mobile computing devices to the serving computing device 114. The serving computing device 114 may communicate some or all of the statistical data to other computing devices for use in gauging shopper interest in products and mapping activities to lost sales. In another example, the statistical data can be used to, for example, analyze customer flow through the retail environment, time spent at different areas of the retail environment, and the like. Such statistical data may be used to determine whether complementary products (e.g., pancake mix and syrup) may need re-positioning with respect to one another by store personnel.

In accordance with embodiments of the present invention, an object having its image displayed on a mobile computing device may be identified in response to determining that information about the object has been accessed. For example, the mobile computing device 104 may be used to capture an image or video of the product 108. The user of the mobile computing device 104 may subsequently use a web browser residing on the mobile computing device 104 to access information on the Internet or another network about the product 108. As an example, the web browser may be used to access a website for nutrition information or other information about the product 108. The control unit 112 may determine that the user interacts with the mobile computing device 104 to access such information about the product 108. In response to determining that the user interacted with the mobile computing device 104 to access information about the object, the control unit 112 may identify the product 108. Further, in response, the control unit 112 may begin, for example, generating statistical data about the product 108, determining time spent capturing an image of the product 108, and/or implementing other processes associated with the product 108 in accordance with embodiments of the present invention.

In another example of interacting with a mobile computing device, the control unit 112 may determine that the user has operated the mobile computing device 104 to access a social network about the product 108. For example, the user may access and use a social network web site to post an image of the product 108, to request information about the product 108, or otherwise identify the product 108 on the web site. In response to determining that the user has accessed the social network in this way, the control unit 112 may identify the product 108. Further, in response, the control unit 112 may begin, for example, generating statistical data about the product 108, determining time spent capturing an image of the product 108, and/or implementing other processes associated with the product 108 in accordance with embodiments of the present invention.

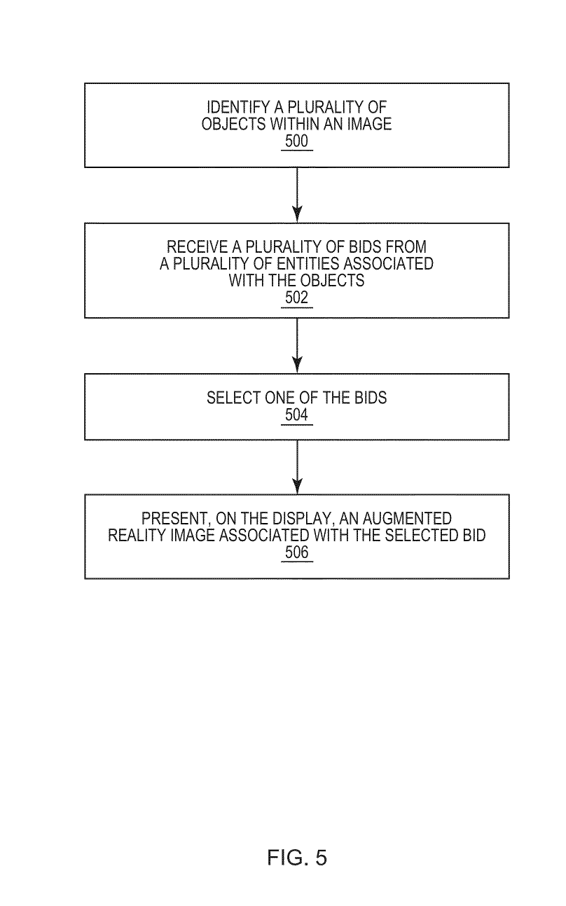

FIG. 5 illustrates a flowchart of an example method for presenting an augmented reality image associated with a selected bid in accordance with embodiments of the present invention. The method of FIG. 5 is described as being implemented by the mobile computing device 104 shown in FIG. 1, although the method may be implemented by any suitable computing device or in combination with another computing device, such as the serving computing device 114. The method may be implemented by hardware, software, and/or firmware of the mobile computing device 104 and/or another computing device.

Referring to FIG. 5, the method includes identifying 500 a plurality of objects within an image. For example, within a retail environment, multiple products may be within view of the activated image capture device 106 of the mobile computing device 104. The image capture device 106 may capture an image or video of the products. The control unit 112 may utilize suitable recognition techniques to identify the products within the captured image or video. In response to identifying the products, the control unit 112 may initiate the collection of statistical data about the products in accordance with embodiments of the present invention. Further, the control unit 112 may communicate such statistical information, user demographic data, user shopping cart content, user shopping history, and/or the like to the serving computing device 114 for distribution to one or more entities in accordance with embodiments of the present invention.

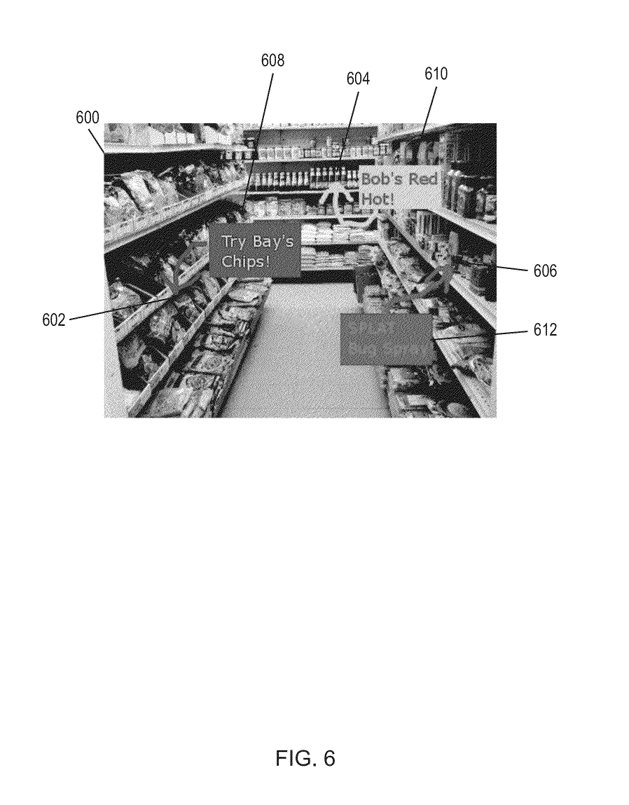

FIG. 6 illustrates a display screen 600 showing an image including multiple products and augmented reality images in accordance with embodiments of the present invention. Referring to FIG. 6, images of multiple products, including a bag of chips 602, a bottle of hot sauce 604, and a canister of insect repellant 606, displayed on the display screen 600. The image was captured when a shopper is positioned at an aisle of a retail store. Some or all of the products may be identified by the control unit 112.

Referring again to FIG. 5, the method includes receiving 502 a plurality of bids from a plurality of entities associated with the objects. Continuing the aforementioned example, the control unit 112 may communicate identification of the products to the serving computing device 114. In response to receipt of the communication, the serving computing device 114 may communicate to entities registered with the remote server 128 identification of the products and other associated information, such as statistical information, user demographic data, user shopping cart content, user shopping history, and/or the like. The entities may generate and submit bids for placement of advertisement and/or other content in accordance with embodiments of the present invention. The bids may be communicated to the remote server 128. The remote server 128 may subsequently communicate the bids to the serving computing device 114. Along with each bid, the entities may provide content, such as an advertisement, for presentation as an augmented reality image if the corresponding bid is selected.

The method of FIG. 5 includes selecting 504 one of the bids. For example, the serving computing device 114 may select one or more of the highest bids from among the bids. In response to selection of the one or more bids, the serving computing device 114 may communicate the content to the mobile computing device 104. Further, the serving computing device 114 may communicate instructions for placement of the content on a display screen of the mobile computing device 104. Other content may include discount information, product nutrition information, text, and the like. A payment transaction may be conducted with entities associated with selected bids in accordance with embodiments of the present invention.

The method of FIG. 5 includes presenting 506, on the display, an augmented reality image associated with the selected bid. Continuing the aforementioned example, the mobile computing device 104 may receive content and instructions for placement of the content. In response to receipt of the content and instructions, the control unit 112 may control the display to display one or more augmented reality images including the content on a display screen of the display 116. The augmented reality image(s) may be displayed along with the captured image or video including the products.

Returning to FIG. 6, an example is provided of multiple augmented reality images 608, 610, and 612 being displayed along with products 602, 604, and 606, respectively, in a captured image. The augmented reality images 608, 610, and 612 may include content corresponding to winning bids. As shown, the augmented reality images 608, 610, and 612 are positioned near their respective products and include an arrow indicating a location of their respective product. Alternatively, any other suitable indicia may be used for showing a location of a corresponding product. As a result, the products 602, 604, and 606 can be differentiated from other products in the aisle. In this way, companies making such products available in stores can pay the retailer to draw the shopper's attention to their products.

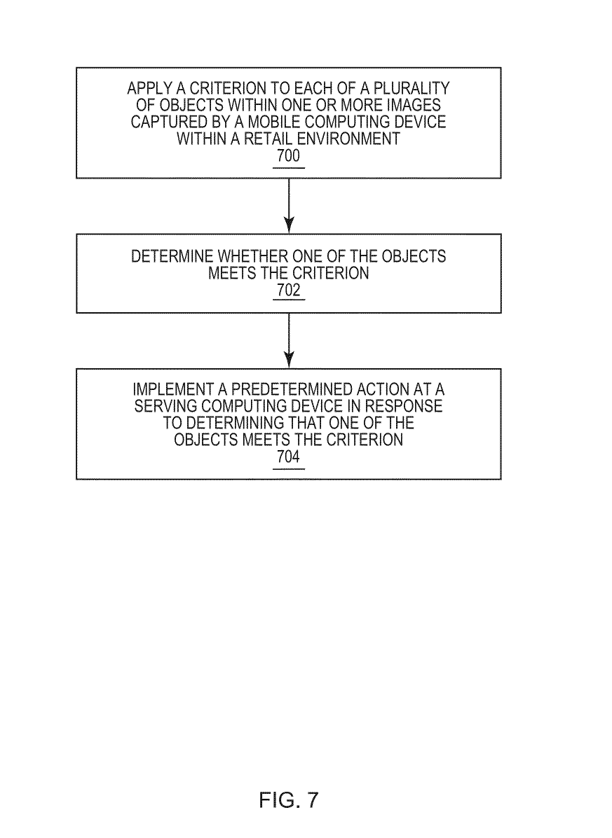

FIG. 7 illustrates a flowchart of an example method for implementing an action at a serving computing device in accordance with embodiments of the present invention. The method of FIG. 7 is described as being implemented by the serving computing device 114 shown in FIG. 1, although the method may be implemented by any suitable computing device or in combination with another computing device, such as the mobile computing device 104. The method may be implemented by hardware, software, and/or firmware of the serving computing device 114 and/or another computing device.

Referring to FIG. 7, the method includes applying 700 a criterion to each of a plurality of objects within one or more images captured by a mobile computing device within a retail environment. For example, the mobile computing device 104 may capture the image of the products shown in FIG. 6. Subsequently, the control unit 112 may identify each of the products and apply a criterion to each of the products. Alternatively, the image may be communicated to the serving computing device 114 for identification of the products and application of a criterion to each of the products. Application of the criterion may involve applying suitable image recognition techniques to identify the products. Application of the criterion may involve applying one or more measures to the object image. In response to determining that a criterion is met, the control unit 112 of the mobile computing device 104 may communicate the image to the serving computing device 114. The communication may to the serving computing device 114 may be automated.

The method of FIG. 7 includes determining 702 whether one or more of the objects meets the criterion. Continuing the aforementioned example, the control unit 112 may determine whether one or more of the products 602, 604, and 606 or another object meets the criterion. Alternatively, the serving computing device 114 may determine whether the criterion is met.

The method of FIG. 7 includes implementing 704 a predetermined action at a serving computing device in response to determining that one of the objects meets the criterion. Continuing the aforementioned example, the object may be one of hazardous (e.g., a spill), contain a sign error (e.g., a misplaced sign in a retail store), and misplaced within a retail environment. As an example, the predetermined action may include alerting personnel or any other suitable action. In an example, retail store personnel may be alerted to a spill on a floor so that it may be timely removed. The serving computing device 114 may suitably implement an alert by displaying it via the user interface 130 or otherwise signaling to personnel within a retail environment. As a result, the attention of personnel can be drawn to the problem without need of the shopper pointing it out, or personnel actually visiting the area to discover the problem.

In accordance with embodiments of the present disclosure, time spent capturing an image or video of a product may be utilized by marketing companies. For example, advertisement effectiveness may be determined based on the time spent.

It is noted that although many of the examples described herein are implemented solely or mostly by a single computing device, such as a mobile computing device, the examples disclosed herein may be implemented by a system of computing devices. For example, the examples disclosed herein may be implemented by a mobile computing device and a serving computing device. In this example, the mobile computing device may capture images, and the mobile computing device may process the images and report processing results to the mobile computing device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
using at least a processor and memory for:
determining a measure of user interaction with a mobile computing device;
determining whether a user attention criterion is met based on the measure; and
in response to determining that the user attention criterion is met, presenting an augmented reality image on a display.

2. The method of claim 1, wherein determining the measure comprises determining an amount of time spent capturing an image of an object, and
wherein determining whether the user attention criterion is met comprises determining whether the user attention criterion is met based on the amount of time spent capturing the image of the object.

3. The method of claim 2, further comprising presenting the image of the object on the display simultaneously with the augmented reality image.

4. The method of claim 2, further comprising using an image capture device of the mobile computing device to capture the image of the object.

5. The method of claim 1, wherein presenting the augmented reality image on the display comprises presenting, on the display, one of an advertisement image, text, discount information, and product nutrition information.

6. The method of claim 1, further comprising:
receiving a plurality of bids from a plurality of entities;
selecting one of the bids, and
wherein the augmented reality image is associated with the selected bid.

7. The method of claim 6, wherein each bid is associated with a different augmented reality image.

8. The method of claim 6, further comprising conducting a payment transaction with the entity associated with the selected bid for presentation of the augmented reality image.

9. The method of claim 6, further comprising communicating to each of the entities one of user demographic data, user shopping cart content, and user shopping history.

10. A method comprising:
using at least a processor and memory of a mobile computing device for:
determining an amount of time spent capturing an image of an object within a retail environment;
generating statistical data associated with the object; and
communicating the amount of time spent and the statistical data to a serving computing device within the retail environment.

11. The method of claim 10, further comprising:
using an image capture device of the mobile computing device to capture images including images of the object; and
identifying the object within the captured images.

12. The method of claim 11, wherein identifying the object comprises determining that one of the object is picked up by a user and the object is placed away.

13. The method of claim 10, further comprising identifying the object based on whether the object is analyzed for nutritional information.

14. The method of claim 10, further comprising:
determining whether a user interacts with the mobile computing device to access information about the object; and
in response to determining that the user interacted with the mobile computing device to access information about the object, identifying the object.

15. The method of claim 14, wherein determining whether the user interacts with the mobile computing device comprises determining whether the user interacts with a social network about the object.

16. A method comprising:
using at least a processor and memory for:
identifying a plurality of objects within an image;
receiving a plurality of bids from a plurality of entities associated with the objects;
selecting one of the bids; and
presenting, on a display, an augmented reality image associated with the selected bid.

17. The method of claim 16, wherein each bid is associated with a different augmented reality image.

18. The method of claim 16, further comprising conducting a payment transaction with the entity associated with the selected bid for presentation of the augmented reality image.

19. The method of claim 16, further comprising communicating to each of the entities one of user demographic data, user shopping cart content, and user shopping history.

20. The method of claim 16, wherein presenting the augmented reality image on the display comprises presenting, on the display, one of an advertisement image, text, discount information, and product nutrition information.

21. The method of claim 16, wherein presenting the augmented reality image on the display comprises presenting, on the display, indicia for indicating a location of one of the objects.

22. A method comprising:
using at least a processor and memory for:
applying a criterion to each of a plurality of objects within one or more images captured by a mobile computing device within a retail environment;
determining whether one of the objects meets the criterion; and
in response to determining that one of the objects meets the criterion, implementing a predetermined action at a serving computing device.

23. The method of claim 22, further comprising communicating to the serving computing device the one or more images in response to determining that one of the objects meets the criterion.

24. The method of claim 22, wherein determining whether the one of the objects meets the criterion comprises recognizing whether the object is one of hazardous, contains a sign error, and misplaced within the retail environment.

25. The method of claim 22, wherein implementing the predetermined action comprises alerting personnel.
